(19) United States
(12) Patent Application Publication
(10) Pub. No.: US 2009/0061164 A1
(43) Pub. Date: Mar. 5, 2009

(54) Cold-Formable Laminate for Blister Base Parts

(76) Inventors: Erwin Pasbrig, Singen (DE); Oliver Brandl, Konstanz (DE)

Correspondence Address: Fisher, Christen & Sabol, 1725 K Street, N.W., Suite 1108, Washington, DC, 20006, US

(21) Appl. No.: 11/992,853

(22) PCT Filed: Oct. 4, 2006
(86) PCT No.: PCT/EP2006/009567

§ 371 Date: Sep. 16, 2008

(30) Foreign Application Priority Data
Oct. 12, 2005 (EP) 05405583.5
Dec. 8, 2005 (EP) 05405692.4

(51) Int. Cl. B32B 3/12

(52) U.S. Cl. 428/178

(57) ABSTRACT

A cold-formable laminate made of an aluminium foil (26, 46) covered on both sides with plastics material for producing base parts of blister packagings for pharmaceutical products which are freeze dried in the base part has the layer sequence
layer A (22)/layer B (24)/aluminium foil (26)/layer C (28)/layer D (30), wherein the layer A is a film 10 to 100 μm thick made of COC/PE blend or coextruded COC-PE, the layers B and C are films 10 to 50 μm thick made of oPA, oPP or PET and the layer D is a film 10 to 100 μm thick made of COC/PE blend, coextruded COC-PE or PVC, the layers A and D being different, or
layer A (22)/layer B (24)/aluminium foil (26)/layer C (28)/layer D (30), wherein the layer A is a film 4 to 20 μm thick made of oPP or PET, the layers B and C are films 10 to 50 μm thick made of oPA or PET and the layer D is a film 10 to 100 μm thick made of COC/PE blend or coextruded COC/PE, or
layer B (44)/aluminium foil (46)/layer C (48)/layer D (50), wherein the layers B and C are films 10 to 50 μm thick made of oPA or PET and the layer D is a coating made of PE with a grammage of 8 to 40 g/m², or
layer B (44)/aluminium foil (46)/layer C (48)/layer D (50), wherein the layers B and C are films 10 to 50 μm thick made of oPA or PET and the layer D is a film 10 to 100 μm thick made of COC/PE blend or coextruded COC/PE.

The invention relates to a cold-formable laminate made of an aluminium foil covered on both sides with plastics material for producing base parts of blister packagings for pharmaceutical products which are freeze dried in wells in the base part.

Cold-formable laminates made of an aluminium foil covered on both sides with plastics material are used, inter alia, for producing base parts of blister packagings for pharmaceutical products. Wells for receiving individual tablets or other forms of individual doses are formed in the base parts. The aluminium foil is used here primarily as a barrier layer against the passage of water vapour and gases and protects the products primarily from absorbing or giving off moisture.

Conventional laminates for producing base parts of blister packagings for pharmaceutical products frequently have the structure oPA/aluminium foil/sealing layer. Conventional sealing layers consist of 15 to 100 μm PVC, 20 to 60 μm PP or 30 to 50 μm PE. After filling the wells, an optionally peelable outer foil is sealed against the base parts. Conventional outer foils are optionally aluminium foils which are coated with plastics material, covered with film or lacquered.

Freeze-dried pharmaceutical products are a new form of drug delivery system (DDS). With this form of administration, the active ingredient is released in the throat and reaches the blood circulation by way of the mucous membranes.

A first method of producing these DDSs is the production of freeze-dried pharmaceutical products and the subsequent filling of the blisters similarly to the packaging of conventional tablets.

A second method for producing these DDSs consists in introducing the pharmaceutical product in liquid form into the wells which are arranged in the base part of a blister packaging and carrying out the freeze drying directly in the wells. However, in practice it has been shown that laminates made of an aluminium foil coated with plastics material tend to roll in under the influence of the temperature change during the freeze drying process.

As a consequence of the production process, in the method with freeze drying carried out directly in the blister base parts, foil portions with blister base parts are punched after the cold-forming of the laminate and the wells thereof are then filled with the pharmaceutical product present in liquid form. The foil portions with the filled wells are then continuously guided through a freezing tunnel. So no liquid can come from the wells onto the sealing layer, the foil portions have to lie flat during the freezing process, i.e. no distortion may occur.

A laminate which is made of an aluminium foil with plastics material layers arranged on both sides is known from EP-A-0 646 367, the layers having substantially the same thermal coefficients of expansion to avoid distortion of the blister base parts during the freeze drying. This condition is fulfilled with an arrangement of identical plastics material layers on both sides.

The invention is based on the object of providing a laminate of the type mentioned at the outset which is suitable for producing base parts of blister packagings for pharmaceutical products which are freeze dried directly in the base part, without the plastics material layers arranged on both sides of the aluminium foil having to have the same thermal coefficients of expansion.

The object is achieved according to the invention in that the laminate has the layer sequence
layer A/layer B/aluminium foil/layer C/layer D, wherein the layer A is a film 10 to 100 μm thick made of COC/PE blend or coextruded COC/PE, the layers B and C are films 10 to 50 μm thick made of oPA, oPP or PET and the layer D is a film 10 to 100 μm thick made of COC/PE blend, coextruded COC-PE or PVC, the layers A and D being different, or
layer A/layer B/aluminium foil/layer C/layer D, wherein the layer A is a film 4 to 20 μm thick made of oPP or PET, the layers B and C are films 10 to 50 μm thick made of oPA or PET and the layer D is a film 10 to 100 μm thick made of COC/PE blend or coextruded COC/PE, or
layer B/aluminium foil/layer C/layer D, wherein the layers B and C are films 10 to 50 μm thick made of oPA or PET and the layer D is a coating made of PE with a grammage of 8 to 40 g/m², or
layer B/aluminium foil/layer C/layer D, wherein the layers B and C are films 10 to 50 μm thick made of oPA or PET and the layer D is a film 10 to 100 μm thick made of COC/PE blend or coextruded COC/PE.

The films of layers A and D made of COC/PE blend, coextruded COC/PE or PVC preferably have a thickness of 15 to 60 μm, the films of the layers A made of oPP or PET have a thickness of 6 to 10 μm and the films of layers B and C have a thickness of 12 to 30 μm. If there is a coating, the layer D has a preferred grammage of 10 to 30 g/m².

The layer D forms the later sealing layer when sealing an outer foil on a base part of a blister packaging produced from the laminate according to the invention.

Apart from the special layer structure, the different chemical composition and/or the different structure of the two outer layers of the laminate is a fundamental feature of the invention.

The aluminium foil is in a flexible state and has a thickness of 20 to 100 μm, preferably 30 to 60 μm.

The individual layers can be connected by covering with solvent-based, solvent-free or aqueous adhesives, by extrusion covering, hot calendering and/or extrusion coating with and without primer.

The film combinations preferred for the laminates according to the invention are compiled in Table 1. The abbreviated designations of the plastics materials on which the films are based mean:

TABLE 1
Preferred laminate structures

| No. | Layer A | Layer B | Al | Layer C | Layer D |
|---|---|---|---|---|---|
| 1 | 25 μm COC/PE blend | 15 μm oPA | 45 μm | 15 μm oPA | 25 μm COC/PE coex |
| 2 | 25 μm COC/PE blend | 15 μm oPA | 60 μm | 15 μm oPA | 25 μm COC/PE coex |
| 3 | 25 μm COC/PE blend | 25 μm oPA | 45 μm | 25 μm oPA | 25 μm COC/PE coex |
| 4 | 25 μm COC/PE blend | 25 μm oPA | 60 μm | 25 μm oPA | 25 μm COC/PE coex |
| 5 | 40 μm COC/PE blend | 15 μm oPA | 45 μm | 15 μm oPA | 40 μm COC/PE coex |
| 6 | 40 μm COC/PE blend | 15 μm oPA | 60 μm | 15 μm oPA | 40 μm COC/PE coex |
| 7 | 40 μm COC/PE blend | 20 μm oPA | 45 μm | 20 μm oPA | 40 μm COC/PE coex |
| 8 | 40 μm COC/PE blend | 20 μm oPA | 60 μm | 20 μm oPA | 40 μm COC/PE coex |
| 9 | 25 μm COC/PE blend | 25 μm oPA | 45 μm | 23 μm PET | 25 μm COC/PE coex |
| 10 | 25 μm COC/PE blend | 25 μm oPA | 60 μm | 23 μm PET | 25 μm COC/PE coex |
| 11 | 25 μm COC/PE coex | 15 μm oPA | 45 μm | 15 μm oPA | 25 μm COC/PE blend |
| 12 | 25 μm COC/PE coex | 15 μm oPA | 60 μm | 15 μm oPA | 25 μm COC/PE blend |
| 13 | 40 μm COC/PE blend | 20 μm oPP | 45 μm | 20 μm oPP | 40 μm COC/PE coex |
| 14 | 40 μm COC/PE blend | 20 μm oPP | 60 μm | 20 μm oPP | 40 μm COC/PE coex |
| 15 | 40 μm COC/PE coex | 20 μm oPA | 45 μm | 20 μm oPA | 15 μm PVC |
| 16 | 40 μm COC/PE coex | 20 μm oPA | 60 μm | 20 μm oPA | 30 μm PVC |
| 17 | 25 μm COC/PE blend | 23 μm PET | 45 μm | 23 μm PET | 25 μm COC/PE coex |
| 18 | 25 μm COC/PE blend | 23 μm PET | 60 μm | 23 μm PET | 25 μm COC/PE blend |
| 19 | 6 μm PET | 15 μm oPA | 45 μm | 15 μm oPA | 25 μm COC/PE coex |
| 20 | 8 μm oPP | 15 μm oPA | 60 μm | 15 μm oPA | 25 μm COC/PE blend |
| 21 | 9 μm PET | 25 μm oPA | 45 μm | 25 μm oPA | 25 μm COC/PE coex |
| 22 | 10 μm oPP | 25 μm oPA | 60 μm | 25 μm oPA | 25 μm COC/PE blend |
| 23 | 9 μm PET | 25 μm oPA | 45 μm | 25 μm oPA | 40 μm COC/PE coex |
| 24 | 10 μm oPP | 25 μm oPA | 60 μm | 25 μm oPA | 40 μm COC/PE blend |
| 25 | 6 μm PET | 15 μm oPA | 45 μm | 12 μm PET | 25 μm COC/PE coex |
| 26 | 8 μm oPP | 15 μm oPA | 60 μm | 12 μm PET | 25 μm COC/PE blend |
| 27 | 9 μm PET | 25 μm oPA | 45 μm | 23 μm PET | 25 μm COC/PE coex |
| 28 | 10 μm oPP | 25 μm oPA | 60 μm | 23 μm PET | 25 μm COC/PE blend |
| 29 | 9 μm PET | 23 μm PET | 45 μm | 23 μm PET | 40 μm COC/PE coex |
| 30 | 10 μm oPP | 23 μm PET | 60 μm | 23 μm PET | 40 μm COC/PE blend |
| 31 | | 15 μm oPA | 45 μm | 15 μm oPA | 10 g/m² PE |
| 32 | | 15 μm oPA | 60 μm | 15 μm oPA | 10 g/m² PE |
| 33 | | 25 μm oPA | 45 μm | 25 μm oPA | 15 g/m² PE |
| 34 | | 25 μm oPA | 60 μm | 25 μm oPA | 15 g/m² PE |
| 35 | | 25 μm oPA | 45 μm | 23 μm PET | 15 g/m² PE |
| 36 | | 25 μm oPA | 60 μm | 23 μm PET | 15 g/m² PE |
| 37 | | 23 μm PET | 45 μm | 23 μm PET | 15 g/m² PE |
| 38 | | 23 μm PET | 60 μm | 23 μm PET | 15 g/m² PE |
| 39 | | 15 μm oPA | 45 μm | 15 μm oPA | 25 μm COC/PE coex |
| 40 | | 15 μm oPA | 60 μm | 15 μm oPA | 25 μm COC/PE blend |
| 41 | | 25 μm oPA | 45 μm | 25 μm oPA | 25 μm COC/PE coex |
| 42 | | 25 μm oPA | 60 μm | 25 μm oPA | 25 μm COC/PE blend |
| 43 | | 25 μm oPA | 45 μm | 25 μm oPA | 40 μm COC/PE coex |
| 44 | | 25 μm oPA | 60 μm | 25 μm oPA | 40 μm COC/PE blend |
| 45 | | 15 μm oPA | 45 μm | 12 μm PET | 25 μm COC/PE coex |
| 46 | | 15 μm oPA | 60 μm | 12 μm PET | 25 μm COC/PE blend |
| 47 | | 25 μm oPA | 45 μm | 23 μm PET | 25 μm COC/PE coex |
| 48 | | 25 μm oPA | 60 μm | 23 μm PET | 25 μm COC/PE blend |
| 49 | | 23 μm PET | 45 μm | 23 μm PET | 40 μm COC/PE coex |
| 50 | | 23 μm PET | 60 μm | 23 μm PET | 40 μm COC/PE blend |

oPA oriented polyamide
oPP oriented polypropylene
PET polyethylene terphthalate
COP cycloolefin polymer
PE polyethylene
PVC polyvinylchloride
COC cycloolefin copolymer

A preferred area of application of the laminate according to the invention is the production of base parts of blister packagings for pharmaceutical products which are freeze dried in wells in the base part.

Further advantages, features and details of the invention emerge from the following description of preferred embodiments and with the aid of the drawings, in which, schematically:

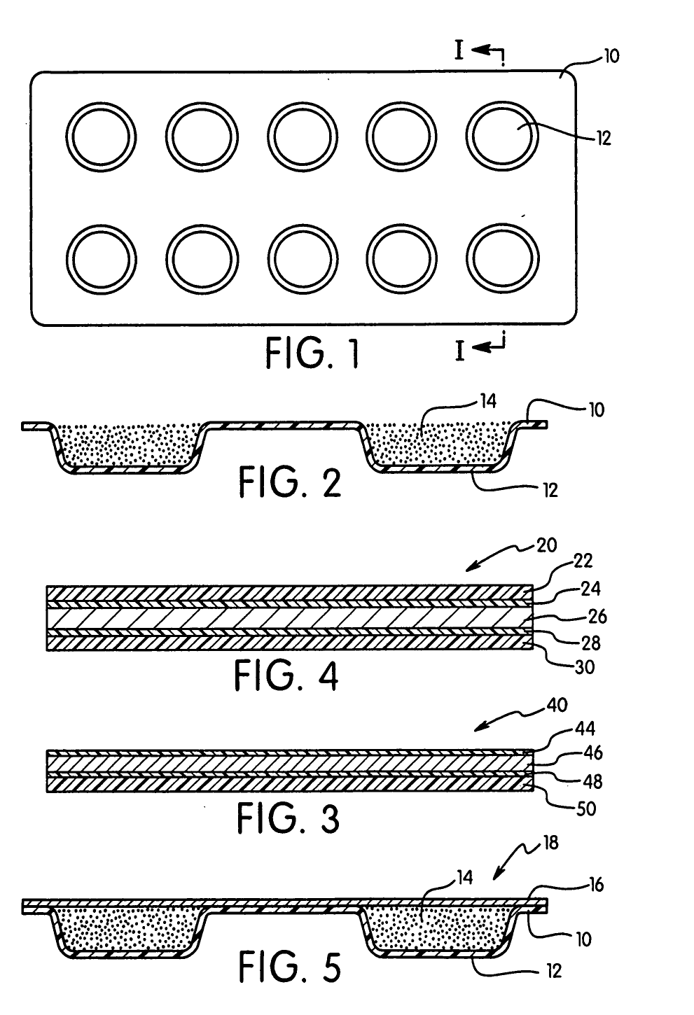

FIG. 1 shows a plan view of a base part of a blister packaging;

FIG. 2 shows a section through the base part of FIG. 1 along the line I-I;

FIG. 3 shows a cross section through a first embodiment of a laminate for producing blister base parts;

FIG. 4 shows a cross section through a second embodiment of a laminate for producing blister base parts;

FIG. 5 shows a cross section through a blister packaging made of a base part with a sealed-on outer foil.

A base part 10 of a blister packaging shown in FIGS. 1 and 2 consists of a laminate, from which depressions in the form of wells 12 are formed by cold-forming. A single dose 14 in liquid form is located in each well 12.

A first laminate 20 which is shown in FIG. 3 for producing the base part 10 has the following layer structure from the outside to the inside:

| | | |
|---|---|---|
| 22 | layer A | for example film made of COC/PE blend, 40 μm thick, |
| | | or film made of PET, 9 μm thick |
| 24 | layer B | for example film made of oPA, 20 μm thick |
| 26 | aluminium | for example 60 μm thick |
| | foil | |
| 28 | layer C | for example film made of oPA, 20 μm thick |
| 30 | layer D | for example film made of COC/PE coex, 40 μm thick |

The layer A is the later outside of a blister base part produced from the laminate 20 and the layer D is the sealing side for sealing on an outer foil.

A second laminate 40 shown in FIG. 4 for producing the base part 10 has the following layer structure from the outside to the inside:

| | | |
|---|---|---|
| 44 | layer B | for example film made of oPA, 15 μm thick |
| 46 | aluminium foil | for example 45 μm thick |
| 48 | layer C | for example film made of oPA, 15 μm thick |
| 50 | layer D | for example coating of PE, 15 g/m², or film made of |
| | | COC/PE coex, 40 μm thick |

The layer B is the later outside of a blister base part produced from the laminate 20 and the layer D is the sealing side for sealing on an outer foil.

During freeze drying with a base part 10 shown in FIG. 1, individual doses 14 of a pharmaceutical product in liquid form are introduced into the wells 14. The base part 10 then runs through a freezing station, in which the individual doses 14 rapidly freeze. The base parts 10 with the frozen individual doses 14 are then freeze dried in a chamber under a vacuum. After the freeze drying, the base parts 10 are closed by sealing on an outer foil 16, for example an aluminium foil, which can preferably be peeled from the base part 10, to produce the finished blister packaging 18.

1. A cold-formable laminate made of an aluminum foil (26, 46) covered on both sides with plastics material for producing base parts (10) of blister packagings (18) for pharmaceutical products (14) which are freeze-dried in the base part, the laminate (20, 40) has the layer sequence:
layer A (22)/layer B (24)/aluminum foil (26)/layer C (28)/layer D (30), wherein the layer A is a film 10 to 100 μm thick made of COC/PE blend or coextruded COC-PE, the layers B and C are films 10 to 50 μm thick made of oPA, oPP or PET and the layer D is a film 10 to 100 μm thick made of COC/PE blend, coextruded COC-PE or PVC, the layers A and D being different, or
layer A (22)/layer B (24)/aluminum foil (26)/layer C (28)/layer D (30), wherein the layer A is a film 4 to 20 μm thick made of oPP or PET, the layers B and C are films 10 to 50 μm thick made of oPA or PET and the layer D is a film 10 to 100 μm thick made of COC/PE blend or coextruded COC/PE, or
layer B (44)/aluminum foil (46)/layer C (48)/layer D (50), wherein the layers B and C are films 10 to 50 μm thick made of oPA or PET and the layer D is a coating made of PE with a grammage of 8 to 40 g/m², or
layer B (44)/aluminum foil (46)/layer C (48)/layer D (50), wherein the layers B and C are films 10 to 50 μm thick made of oPA or PET and the layer D is a film 10 to 100 μm thick made of COC/PE blend or coextruded COC/PE.

2. The laminate according to claim 1, wherein the films of the layers A (22) and D (30, 50) which are made of COC/PE blend or coextruded COC-PE or PVC have a thickness of 15 to 60 μm.

3. The laminate according to claim 1, wherein the films of the layers A (42) which are made of oPP or PET have a thickness of 6 to 10 μm.

4. The laminate according to claim 1, wherein the films of the layers B (24, 44) and C (28, 48) have a thickness of 12 to 30 μm.

5. The laminate according to claim 1, wherein the coating of the layer D (50) has a grammage of 10 to 30 g/m².

6. The laminate according to claim 1, wherein the aluminum foil (26, 46) has a thickness of 20 to 100 μm.

7. A process of utilizing a laminate (20, 40) according to claim 1 to produce base parts (10) of blister packagings (18) for pharmaceutical products (14) which are freeze-dried in wells (12) in the base part (10).

8. The laminate according to claim 1, wherein the aluminum foil (26, 46) has a thickness of 30 to 60 μm.

9. A process of utilizing a laminate (20, 40) according to claim 2 to produce base parts (10) of blister packagings (18) for pharmaceutical products (14) which are freeze-dried in wells (12) in the base part (10).

10. A process of utilizing a laminate (20, 40) according to claim 3 to produce base parts (10) of blister packagings (18) for pharmaceutical products (14) which are freeze-dried in wells (12) in the base part (10).

11. A process of utilizing a laminate (20, 40) according to claim 4 to produce base parts (10) of blister packagings (18) for pharmaceutical products (14) which are freeze-dried in wells (12) in the base part (10).

12. A process of utilizing a laminate (20, 40) according to claim 5 to produce base parts (10) of blister packagings (18) for pharmaceutical products (14) which are freeze-dried in wells (12) in the base part (10).

13. A process of utilizing a laminate (20, 40) according to claim 6 to produce base parts (10) of blister packagings (18) for pharmaceutical products (14) which are freeze-dried in wells (12) in the base part (10).

14. A process of utilizing a laminate (20, 40) according to claim 8 to produce base parts (10) of blister packagings (18) for pharmaceutical products (14) which are freeze-dried in wells (12) in the base part (10).
